(19) United States
(12) Patent Application Publication
(10) Pub. No.: US 2005/0125683 A1
(43) Pub. Date: Jun. 9, 2005

(54) Information acquisition system, information acquisition method and information processing program

(75) Inventors: Shinako Matsuyama, Tokyo (JP); Kenzo Akagiri, Kanagawa (JP); Koji Suginuma, Tokyo (JP)

Correspondence Address: Randy J. Pritzker;Wolf, Greenfield & Sacks, P.C., 600 Atlantic Avenue, Boston, MA, 02210-2206, US

(73) Assignee: Sony Corporation, Tokyo (JP)

(21) Appl. No.: 10/985,729

(22) Filed: Nov. 10, 2004

(30) Foreign Application Priority Data
Nov. 14, 2003 (JP) JP2003-385546

(51) Int. Cl. H04L 9/00; H04L 9/32

(52) U.S. Cl. 713/189; 380/277

(57) ABSTRACT

It is envisaged to relieve the load imposed on the authentication processing as anonymity is maintained to prevent the leakage of the private information, such as taste information of a user. In an information acquisition system 1, a storage server 2 encrypts contents data and other information provided, in their entirety, using a common cipher key for data encryption DEK, and stores the encrypted information as encrypted data EN (DATA). The storage server 2 further encrypts the cipher key for data encryption DEK, as the key information of the encrypted data EN (DEK), using cipher key data KEK, and publicizes the encrypted data EN (DATA), encrypted with the cipher key for encryption DEK, and the encrypted key data EN (DEK), encrypted with the cipher key data KEK. An information processing terminal 3 encrypts the retrieval key word, by the cipher key data KEK, received from the management server 4, and retrieves the encrypted data EN (DATA), stored in the storage server 2, by the encrypted retrieval keyword EN (REF).

### BACKGROUND OF THE INVENTION

1. Field of the Invention

This invention relates to an information acquisition system, an information acquisition method and an information processing program. More particularly, it relates to an information acquisition system and an information acquisition method for acquiring the information conforming to the conditions for retrieval, as selected from the experience information pertinent to an event experienced by a user, and from the private information privately needed by the user, and to an information processing program for having an information processing terminal execute the processing of acquiring the information conforming to the conditions for retrieval, as selected from the experience information pertinent to an event experienced by a user, and from the private information privately needed by the user.

This application claims priority of Japanese Patent Application No. 2003-385546, filed on Nov. 14, 2003, the entirety of which is incorporated by reference herein.

2. Description of Related Art

Recently, with the progress in the network structure, such as the so-called Internet, and with the widespread use of a large-capacity recording medium, an environment for providing or acquiring the voluminous information is being put into order. In keeping up therewith, a large variety of information providing services have been proposed and, in these information providing services, attempts are being made for handling a large quantity of the information efficiently and efficaciously.

As an example, an information providing party extracts the taste of each user as an information accepting party to feature each individual to supply the information or services best fitted to each individual (personalization of the information provided). This technique is used in on-line services allowing for purchase of articles of commerce from a site on the Internet. By introducing the information personalization, the services which allow for purchase of books on the Internet have realized the function of presenting recommended books to a user who purchased a book, from a list of works of the author of the book purchased by the user, the function of presenting other books purchased by other users who purchased the same book as that purchased by the user, the function of the apprising other users of the information the user feels useful for the other users. The party accepting the information (the party browsing the information) is able to change the operating conditions or setting according to the taste of the user (customization). For example, the responsive properties of a mouse, the window coloring or the fonts can be changed.

Such as system which, by the above information personalization or customization, enables the efficient and efficacious use of the information, has already been known. As a developing phase of the personalization, such techniques as real-time profiling of the user's behavior on the network, learning the user's operating habit to provide the user with the GUI suited to the use's taste, or monitoring the user's reaction to observe the taste or the reaction of the user to the contents recommended by an agent.

As described above, the so-called push-type information furnishing, in which the information supplied by the provider is tailored to the individual user to provide a party desiring the information or services with the optimum information, becomes possible, while the party accepting the information may acquire the desired information extremely readily.

However, for tailoring the information provided to each individual (personalization), the information provider has to collect the individual level information, by enquetes, through paper medium or Internet sites, or to collect the behavior hysteresis (purchase hysteresis of books in the above example) of the individual users. Among the information providing services, employing the Internet, there is such a service consisting in collecting the fee information pertinent to a marriage ceremony, a reception hall, an English school or a variety of culture schools, or the information pertinent to the atmosphere or service contents, from those who utilized these in the past, such as by enquetes, fitting the collected results to the rules already determined, and by displaying together the matched information, that is, the information pertinent to establishments or the experience information from the user, on a display image surface, to provide a latent user with the information in determining the establishments or the service providers.

If, in these information providing services, the information is to be made available among plural users, the retrieving step in retrieving the desired information from a large quantity of the text information is simplified by having the user intending to lay open his/her experience data furnish the information, depending on the experience level, and by visualizing the collected experience data of the users in order for the user retrieving the information to acquire the information of high fidelity (information close to the desired information), as disclosed for example in Patent Publication 1.

There has also been presented a technique in which, for effectively narrowing down the targets for distribution of the diversified information, the requirements for information receipt as desired by the information recipient and the requirements for information transmission as desired by the information sender are entered and the distribution of the information from the sender to the recipient is allowed in case of coincidence of the two requirements (see for example the Patent Publication 2).

In the technique described in this Patent Publication 1, the majority of the information, collected from those who already exploited the ceremony halls and reception halls, is the text information, and hence it is difficult to recognize readily whether or not the information contents on which the user places emphasis are contained in the text information furnished. Thus, with the conventional system, a large quantity of the text information, which inherently is not needed, has to be read, with the result that it is frequently difficult to find the information needed by the user.

In the conventional system for providing contents based on the users tastes, basically (1) the user exploits a retrieving engine to retrieve contents to select the desired information, or (2) the service provider analyzes the user's tastes to recommend the information felt to suit to the user's tastes for the user. However, since the voluminous information is now presentable (available) under the present-day information providing environment, the technique (1) imposes significant load on the user, because the user is compelled to select the retrieval condition at a time point of inputting the retrieval keyword, such that retrieval of the needed contents to search the desired information is extremely labor-consuming to increase the load imposed on the user.

On the other hand, the technique (2) is such a technique in which a service provider selects the information presented to the user, that is, the information presented is matched to the individual user (personalization). With this technique, the service provider (information provider) exploits search artifices to extract a user taste model. The information provider, desirous to present the services desired by the individual users, has to group a number of users having the same tastes together to recommend or not to recommend the information preferred or not preferred by an individual to other members in the group. An example of such technique is a technique known as a concerted filtering. However, with the technique of (2), the information presented based on the taste model, extracted by the service provider, is not necessarily matched to the information desired by the users.

The analysis that a number of users grouped together under a preset condition will have the tastes in common is carried out using a data mining technique or a statistic technique. However, there are occasions where the plural users, grouped together in accordance with preset conditions, differ in the process or factors that lead to similar tastes, as a result of which the intricate tastes of the users, grouped together, may not necessarily be reflected by the analysis. On the other hand, the subjective turn of mind of the individual user also may not be reflected in such analysis.

Moreover, the scheme of recommending the user's taste information to the group, imparting the user's private information to the service provider, tends to raise the privacy problem. In addition, in providing the above services, the conventional client server communication system is in reed of a system construction for authentication and for affording the access rights, with the result that the processing load is imposed on the entire system, while anonymity may hardly be achieved. Furthermore, since the commodity purchase hysteresis or the access hysteresis of the user is thereby known, it may be feared that the information close to the private information, identifying the user, may leak to service providers or to the transmission channel, thus possibly leading to illicit use of the information.
[Patent Publication 1] Japanese Laid-Open Patent Publication 2003-16202
[Patent Publication 2] Japanese Laid-Open Patent Publication H9-91358

### SUMMARY OF THE INVENTION

It is an object of the present invention to provide an information acquisition system and an information acquisition method in which it is possible to relieve the load otherwise imposed on authentication processing, as anonymity is maintained to prevent leakage of the private information, such as users taste information, and to permit the user to acquire the optimum information, and an information processing program which will permit an information processing terminal to execute the processing of acquiring the information optimum for the user.

In one aspect, the present invention provides an information acquisition system comprising: an information providing device, including data storage means, having data stored therein, and data transmitting means for transmitting data specified from said stored data to outside; an information processing terminal, including taste information acquisition means for acquiring information representing a taste of a user, retrieval information generating means for generating retrieval information based on the taste information acquired, information retrieving means for retrieving the information matched to the generated retrieval information from said information providing device, and information presenting means for presenting the retrieved result to said user; and a management device for supervising the connection of said information processing terminal to said information providing device; and wherein said information providing device, said information processing terminal and the management device being interconnected over a network.

The information processing terminal includes, as said taste information acquisition means, information acquisition means for acquiring experience information pertinent to an event experienced by the user; private information adding means for adding private information, privately needed by the user, as an evaluation value, to the experience information acquired; storage means for storing said experience information and the private information; data storage controlling means for classifying the experience information, added by said private information in said private information adding means, based on attributes, and for storing the classified experience information in said storage means; and correlation calculating means for calculating a correlation value among said evaluated values; and wherein said information retrieving means retrieves the information matched to the information featured by said correlation value, as the retrieval information, from said information providing device; and wherein said information presenting mans presents the retrieved result for said user.

For improving secrecy in the information acquisition system according to the present invention, the management device includes cipher key generating means for generating a cipher key for supervising the connection of said information processing terminal to said information providing device; and wherein said information providing device includes cipher key generating means for generating a cipher key for data encryption, used for encrypting data stored in said data storage means, with the cipher key having been received over said network from said management device, and key encrypting means for encrypting the cipher key for data encryption, generated in said cipher key generating means, with encrypted data and the encrypted cipher key being stored in said data storage means; and wherein said information processing terminal includes retrieval information encrypting means for encrypting said retrieval information with the cipher key received over said network from said management device, cipher key decoding means for decoding the encrypted cipher key for data encryption, stored in said data storage means, by the cipher key received from said management device, data decoding means for decoding the encrypted data by the cipher key for data encryption decoded, and comparing means for comparing the encrypted retrieval information to the encrypted data. The retrieval information and data of the data storage means are compared to each other, by transmitting/receiving the encrypted retrieval information and the encrypted data on a transmission channel between the information processing terminal and an information providing device.

In another aspect, the present invention provides an information acquisition method for acquiring information stored in an information providing device, by use of an information processing terminal of a user, said information providing device and the information processing terminal being interconnected, along with a management device, over a network, said information providing device including data storage means having data stored therein, said method comprising: a taste information acquisition step of acquiring information representing a taste of the user in said information processing terminal; a retrieval information generating step for generating the retrieval information based on the taste information acquired; an information retrieving step of retrieving the information matched to the generated retrieval information, from said information providing device; and an information presenting step of presenting retrieved results to said user.

An information processing program according to the present invention allows a computer-controlled information processing terminal to acquire the taste information of a user from an information processing terminal in a taste information acquisition step, to generate the retrieval information based on the so acquired taste information and to retrieve the information matched to the so generated retrieval information form the information providing device.

The taste information acquisition step includes an information acquisition step of acquiring experience information pertinent to an event experienced by the user; a private information adding step of adding the private information, as needed privately by the user, to the experience information acquired, as an evaluation value; a storage step of storing said experience information and the private information in storage means; a data storage controlling step of classifying the experience information, added by said private information in said private information adding step, according to attributes, for storage in said storage means; and a correlation calculating step of calculating a correlation value among said evaluation values; wherein by use of the information featured by said correlation value, as the retrieval information, the information matched to said retrieval information is retrieved in said information retrieving step, and wherein the retrieved result is presented to said user in said information presenting step.

For improving the secrecy, there are provided an encryption key generating step of generating a cipher key for supervising the connection of said information processing terminal to said information providing device, in said management device; a cipher key generating step of generating a cipher key for data encryption for encrypting data stored in said data storage means, and a key encrypting step of encrypting the cipher key for data encryption, generated in said cipher key generating step, by use of a cipher key received over said network from said management device, in said information presenting terminal; and a retrieval information encrypting step of encrypting said retrieval information by the cipher key received from said management device over said network, a cipher key decoding step of decoding the cipher key for data encryption, stored in said data storage means, by use of the cipher key received from said management device, a data decoding step of decoding the encrypted data by the cipher key for data encryption decoded, and a comparing step of comparing said encrypted retrieval information to said encrypted data, in said information processing terminal. Hence, the data of the data storage means are encrypted by a cipher key for data encryption, which cipher key for data encryption is encrypted by a cipher key received from the management device over the network. The information terminal decodes the cipher key for data encryption, using the cipher key received from the management device over the network and compares the data of the data storage means and the retrieval information in the encrypted state.

According to the information acquisition apparatus of the present invention, there is no necessity of publicizing the taste information of the user of the information processing terminal to the information providing device. The information providing device only has to encrypt and publicize the necessary information, while it is unnecessary to perform the processing for personal authentication or accessing allowance for an accessing user each time.

The present invention provides a system in which a user's information processing terminal acquires the particular information from the information stored in a server. The system finds the user's taste information, based on the information pertinent to the event experienced by the user and the information needed by the user, and the information which is in keeping with the taste information may automatically be acquired from the server.

The present invention applies this to a scheme of storing the information pertinent to the event experienced by the user and the information needed by the user for utilization later on. In a concrete example of the present invention, the information needed by the user is termed the private information. The users private information is a mark applied for comprehensibly indicating the information acquired and desired to be used again, or an evaluation value pertinent to the acquired information, and is entered in association with the information pertinent to the event experienced by the user.

According to the present invention, the date and time of a user's experience, as well as the image and the speech then recorded, are stored as the information pertinent to the event experienced by the user. The additional information as entered by the user in connection with the experienced event is handled as the private information. For example, if a user has purchased a certain commodity, the information on the date/time of purchase or the position of the store where the commodity was purchased, represents the information on the experienced event, whilst the user's impression or the lesson, obtained form the experience, such as the evaluation on the site of the store, on the services rendered or on the purchased commodity, or the grounds for such evaluation, and which is entered as ‘memoranda’, represents the user's private information. In the present concrete example, the impression on the experience, or the instances of success or failure, added by marks or evaluation values, are stored, along with the information on the experienced event, for use later on. If the stored information is to be utilized, it is sufficient that the user inputs the retrieval condition, in which case the information on the like past experience can be taken out if such experience was made. For example, if the user visited the same place in the past, the information, such as the date/time of such visit, and the information on the purchased commodities, is presented, along with the private information, such as the evaluation.

In the present concrete example, correlation values, among evaluated values, input for an event experienced by a user, as typical of the user's taste information, are calculated, and the attributes or items, corresponding to the value of correlation, are used as retrieval keyword. Moreover, according to the present invention, data acquired from a server are encrypted, and the so encrypted data is compared to the encrypted retrieval information, in order to relieve the load on authentication processing and in order to prevent the leakage of the private information, such as user's taste information, as anonymity is maintained.

### BRIEF DESCRIPTION OF THE DRAWINGS

FIG. 1 illustrates the concept of the information acquisition system of the present invention.

FIG. 2 illustrates an information acquisition system as a concrete example of the present invention.

FIG. 3 is a timing chart for illustrating the information retrieval acquisition processing in the information acquisition system of the present invention.

FIG. 4 is a schematic view for illustrating an information processing terminal in the information acquisition system of the present invention.

FIG. 5 is a schematic view for illustrating a storage server in the information acquisition system of the present invention.

FIG. 6 is a schematic view for illustrating a management server in the information acquisition system of the present invention.

FIG. 7 illustrates an example of a key management method in a management server in the information acquisition system.

FIG. 8 is a schematic block diagram for illustrating the information processing terminal applied to an information acquisition system as a concrete example of the present invention.

FIG. 9 illustrates the management of the private information employing an information processing terminal applied to an information acquisition system as a concrete example of the present invention.

FIG. 10 is a schematic view for illustrating the information processing terminal.

FIG. 11 is a flowchart for illustrating the information registration processing in an information registration phase in the information processing terminal.

FIG. 12 is a flowchart for illustrating the information exploiting processing in an information registration phase in the information processing terminal.

FIG. 13 illustrates an example of the experience information acquired in the information processing terminal.

FIG. 14 illustrates an example of the experience information entered by a user in the information processing terminal.

FIG. 15 illustrates an example of the current information acquired in the information registration phase in the information processing terminal.

FIG. 16 illustrates an example of the retrieval condition entered in the information exploiting phase in the information processing terminal.

FIG. 17 illustrates typical data used as a retrieval condition in the information processing terminal.

FIG. 18 illustrates typical data used as the retrieval result in the information processing terminal.

FIG. 19 schematically shows the correlation between the variegated experience information and the variegated private information as acquired in the information processing terminal.

FIG. 20 is a schematic view for illustrating the processing of a data processor 59 of the information processing terminal finding the correlation data for five stages of the evaluation values entered by the user.

FIG. 21 is a schematic view for illustrating the processing of a data processor 59 of the information processing terminal finding the correlation data for five stages of the evaluation values entered by the user.

FIG. 22 is a schematic view for illustrating the processing of a data processor 59 of the information processing terminal finding the correlation data for five stages of the evaluation values entered by the user.

### DESCRIPTION OF THE PREFERRED EMBODIMENTS

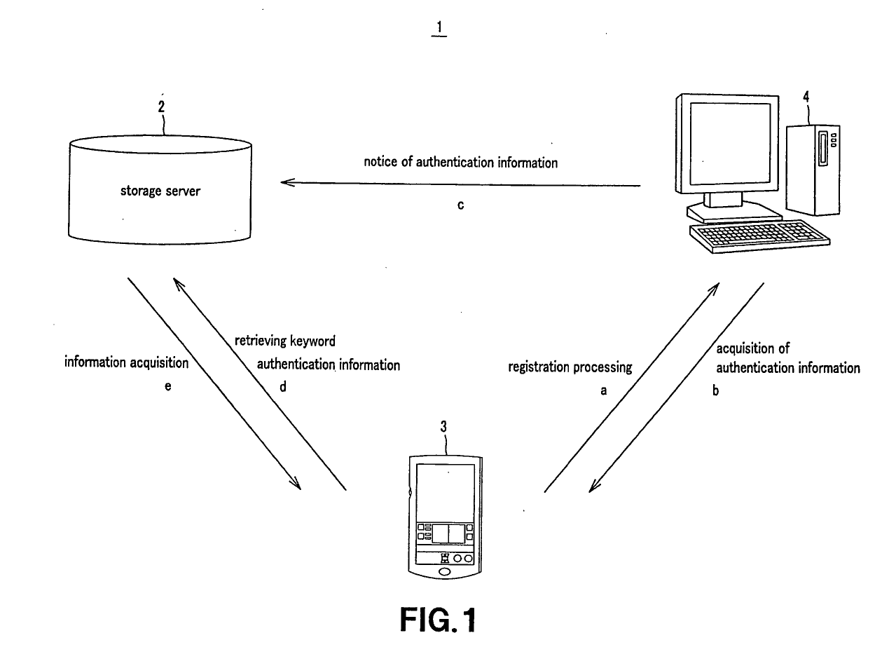

FIG. 1 shows schematics of an information acquisition system 1, shown as a concrete example of the present invention. The information acquisition system 1 includes a storage server 2, having contents stored therein, an information processing terminal 3, capable of acquiring representing the taste of the user of the system, and a management server 4 supervising the connection of the information processing terminal 3 to the storage server 2, these components of the system being connected to one another for communication reciprocally. Although the reciprocal communication is represented in FIG. 1 independently for ease of explanation, the system components are interconnected over a network, such as Intranet or Internet, by wired or wireless connection.

It is desirable that the information processing terminal 3 is carried about at all times by the user. Thus, in the present concrete example, the information processing terminal 3 may be a portable type electronic device, that is, a mobile phone or PDA (Personal Digital Assistant), or a small-sized mobile PC. Although not shown, plural information processing terminals are connectable to the present system. The user of the information processing terminal 3 is provided with the information from the storage server 2. The storage server 2 is used by a business proprietor supplied with the information from the storage server 2.

The management server 4 is used by a management organization taking charge of providing the information processing terminal 3 of the storage server 2. The management server issues the information, which is used by an organization supervising the information provision for the information processing terminal 3 of the storage server 2, and which enables the browsing of the information provided by the storage server 2, from one information processing terminal to another or from a group classed by the feature of the terminals or the users to another. This information is referred to below as the authenticating information. The management server 4 also has the function of settlement against chargeable utilization by the user, as necessary.

In this information acquisition system 1, the user first has to make registration in the management server 4, for exploiting the present system. The user performs the processing of accessing to and making registration in the management server 4, using the information processing terminal 3 (a of FIG. 1). At this time, the user acquires the authenticating information from the management server 4 (b of FIG. 1). This information is simultaneously sent to the server 2 (c of FIG. 1) and used for collation in the information processing terminal 3. A retrieval keyword, entered from the information processing terminal 3, is sent along with the authenticating information to the server 2 (d of FIG. 1). The information corresponding to the retrieval keyword is obtained from the storage server 2 (e of FIG. 1).

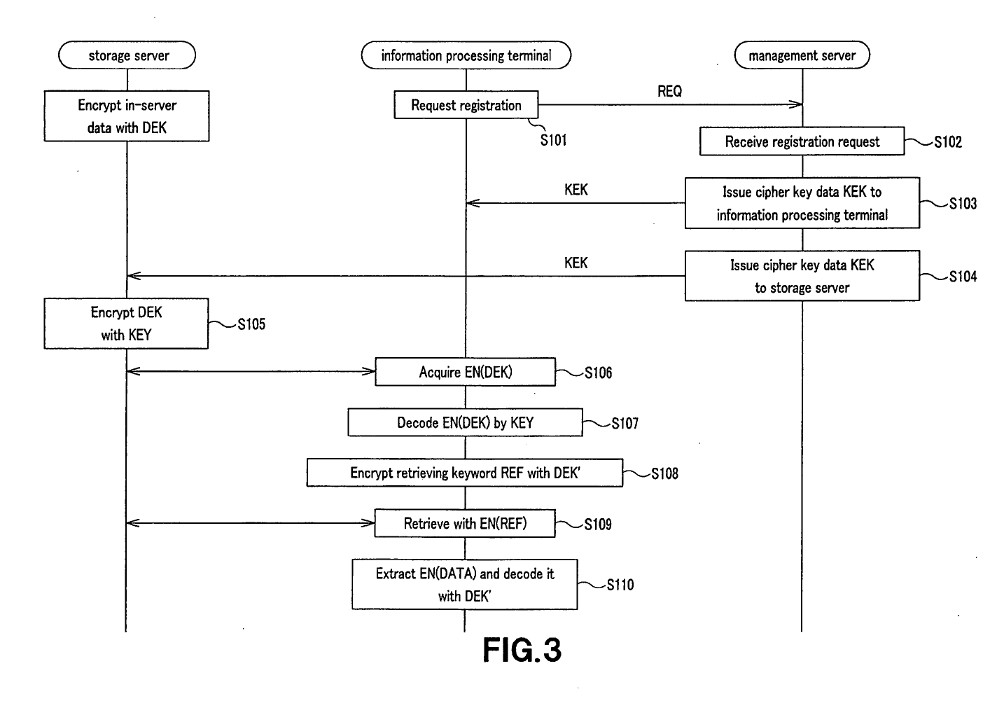

In the present embodiment, the encrypting processing, explained below as an example, is introduced for raising the secrecy of data exchanged between the user and the server. FIG. 3 depicts a timing chart of the processing for retrieving the encrypted information.

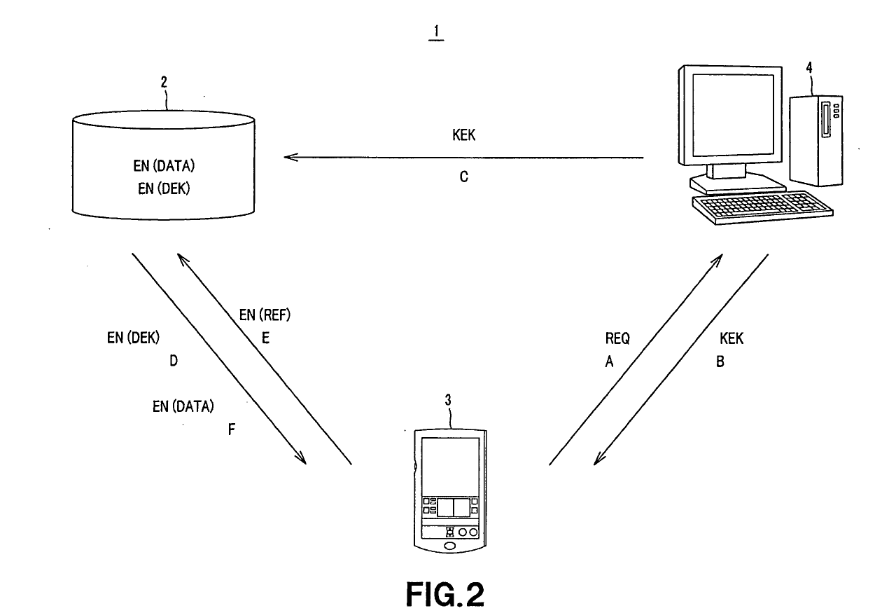

In the information acquisition system 1, the storage server 2 encrypts the contents data, and the information to be supplied, with a common cipher key for encryption DEK, to store resulting encrypted data EN (DATA). The information processing terminal 3 in a step S101 transmits a registration request REQ, required for exploiting the system, to the management server 4 (A of FIG. 2). On receipt in a step S102 of the registration request REQ, the management server 4 in a step S104 issues cipher key data KEK to the information processing terminal 3 (B of FIG. 2). At this time, the management server 4 in a step S104 provides the cipher key data KEK, provided to the information processing terminal 3, to the storage server 2 (C of FIG. 2). Instead of performing this processing from time to time, the cipher key data KEK, provided to the information processing terminal 3, may be sent in a lump from the management server 4 to the storage server 2.

In a step S105, the storage server 2 further encrypts the cipher key for encryption DEK, as the key information of the encrypted data EN (DATA), using the cipher key KEK, to obtain encrypted key data EN (DEK). Thus, in the storage server 2, the encrypted data EN (DATA), encrypted with the cipher key for encryption DEK, and the encrypted key data EN (DEK), encrypted with the cipher key KEK, are publicized.

In a step S106, the information processing terminal 3 accesses the storage server 2 to acquire the encrypted key data EN (DEK) (D of FIG. 2). In a step S107, the information processing terminal 3 decodes the encrypted key data EN (DEK), based on the cipher key data KEK, to acquire the cipher key for encryption DEK. The information processing terminal 3 in a step S108 encrypts a retrieval keyword REF, using a cipher key for data encryption DEK, to acquire an encrypted retrieval keyword EN (REF). This cipher key for data encryption DEK is a transient cipher key, as determined by the information processing terminal 3, and differs from the DEK of the step S105.

In a step S109, the information processing terminal 3 retrieves the encrypted data EN (DATA), stored in the storage server 2, by the encrypted retrieval keyword EN (REF) (E of FIG. 2). The information processing terminal 3 acquires the encrypted data EN (DATA) matched to the encrypted retrieval keyword EN (REF) (F of FIG. 2) and, in a step S110, decodes the encrypted data with the cipher key for data encryption DEK′ to use the so decoded data,.

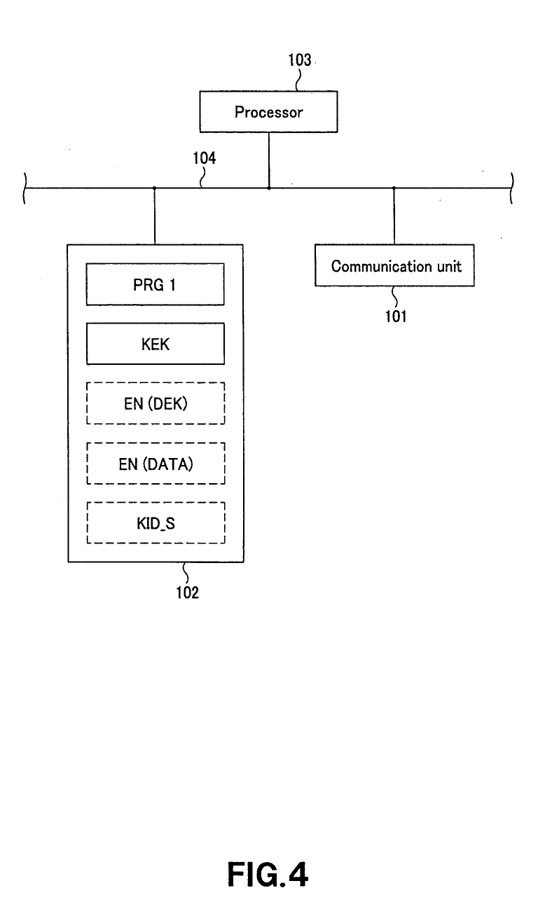

The components of the information acquisition system 1, shown in FIG. 2, are now explained. The configuration of the information processing terminal 3, shown in FIG. 2, is shown in FIG. 4. The information processing terminal 3 includes e.g. a communication unit 101, a memory 102 and a processor 103, interconnected over a bus 104. The communication unit 101 exchanges data with the storage server 2 and the management server 4 over communication circuitry, such as a network. The memory 102 stores a program PRG1, run by the processor 103 and variable data, used in running the program PRG1. The processor 103 comprehensively controls the processing of the information processing terminal 3, as later explained, in accordance with the program PRG1 stored in the memory 102.

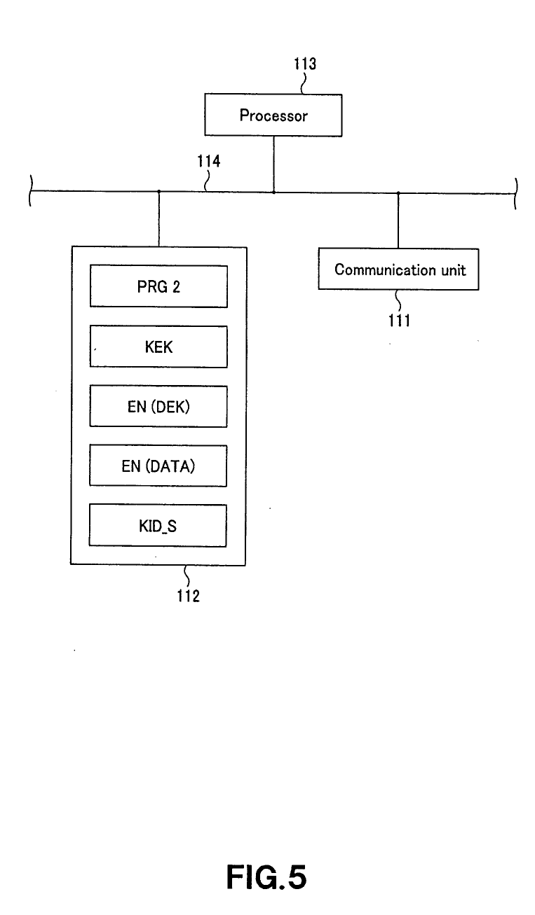

The configuration of the storage server 2 is explained with reference to FIG. 5. The storage server 2 includes e.g. a communication unit 111, a memory 112 and a processor 113, interconnected over a bus 114. The communication unit 111 exchanges data with the information processing terminal 3 and with the management server 4 over communication circuitry, such as a network. The memory 112 stores a program PRG2 run by the processor 113, and variable data, used in running the program PRG2. The processor 113 comprehensively controls the processing of the information processing terminal 3, as later explained, in accordance with the program PRG2 stored in the memory 112.

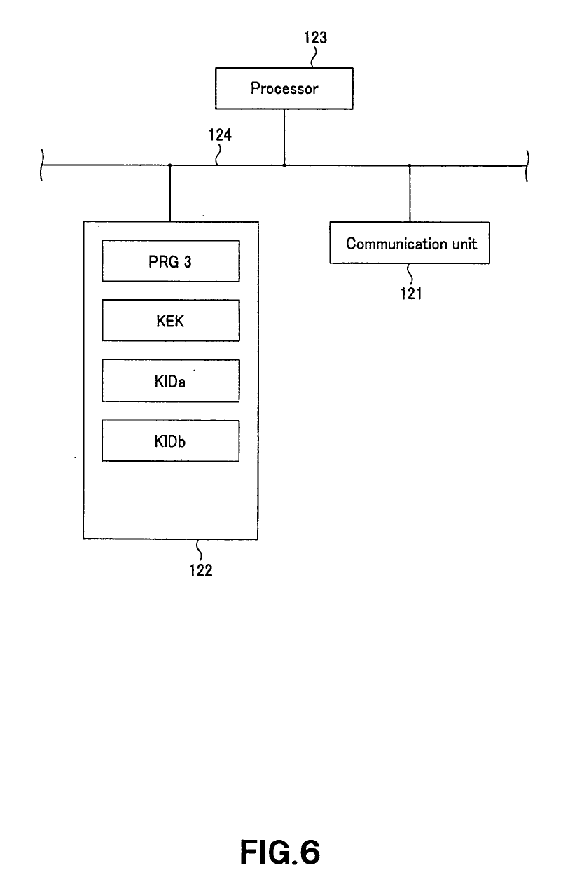

The configuration of the management server 4 is now explained using FIG. 6. The management server 4 includes e.g. a communication unit 121, a memory 122 and a processor 123, interconnected over a bus 124. The communication unit 121 exchanges data with the information processing terminal 3 and with the storage server 2 over communication circuitry, such as a network. The memory 112 stores a program PRG3 run by the processor 123 and variable data, used in running the program PRG3. The processor 123 comprehensively controls the processing of the management server 4, as later explained, in accordance with the program PRG3 stored in the memory 122. The management server 4 transmits plural cipher key data KEK to the information processing terminal 3 based on a preset key management method. The plural cipher key data KEK are used for encrypting the key data used by the storage server 2 in generating cipher data and for transmitting the resultant encrypted key data to the information processing terminal 3.

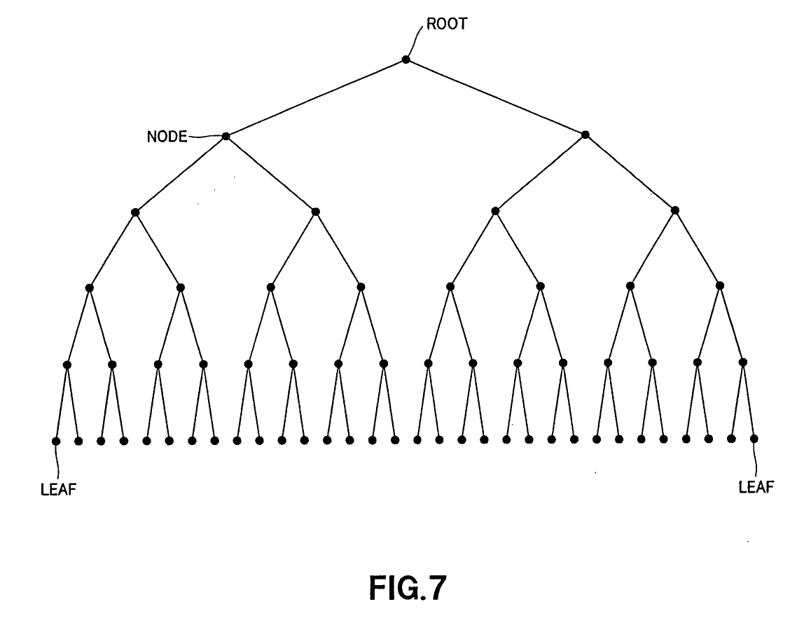

Referring to FIG. 7, an illustrative key management method in the management server 4 is now explained. Referring to FIG. 7, the management server 4 allocates the information processing terminal 3 to a leaf of each tree 60, by a logical key hierarchy (LKH) which is based on a tree 60 in which each node has two branches. The management server prescribes plural sets, each having, as elements, a sole information processing terminal 3 and plural information processing terminals 3, different from one another. The management server 4 also allocates different cipher key data KEK to each set. At the time of registration, the management server 4 transmits, to each of the information processing terminals 3, the cipher key data KEK, allocated to the set of which the information processing terminal is an element. The management server 4 specifies the set, having the information processing terminal with non-cancelled registration, as element, and transmits key identifying data KIDa, KIDb, specifying cipher key data KEK, allocated to this set, to the storage server 2. In the present concrete example, the registration is cancelled in case predetermined registration time of the information processing terminal for the management server 4 has elapsed, in case a request has been made from the information processing terminal is made, or in case the information processing terminal has committed an act violating the registration contract.

Recently, there is a program, termed a “mobile agent”, adapted for executing preset processing as it moves through devices interconnected to form a network. In the concrete example of the present invention, this mobile agent is used to execute the information acquisition processing from the server connected to the network. The mobile agent is then able to automatically download the information, suited to the user's taste, during e.g. the time of charging or standby time when the information processing terminal 3 is not in use, in case the information is needed by the user, without the user having to retrieve the contents each time the information is needed.

When the user retrieves the information concerning an item ‘restaurant’, he/she enters the retrieval condition which reflects the user's taste information pertinent to the restaurant. The taste information may be enumerated, for example, by atmosphere, taste, place and genre (e.g. Italian or French). The information processing terminal 3 generates the retrieval information for retrieval to select the restaurant information matched to the retrieval condition from the restaurant research site. In the present concrete example, information selection and acquisition is carried out automatically. In particular, by storing the information acquired by past experiences, the information downloading may be carried out automatically by the software (mobile agent) in the information processing terminal 3 during e.g. the time of charging or standby time when the information processing terminal is not busy.

Moreover, in the present concrete example, the user's taste information is encrypted by the server of the service provider (storage server 2), so that the users private information is not publicized in an undefended fashion by the storage server 2. In addition, even if the information is picked up on the transmission channel up to the storage server 2, the secrecy of the information pertinent to the user is high because the retrieval keyword REF is encrypted using the cipher key for encryption DEK. With the service providing site, it is only necessary to publicize the necessary information, while it is unnecessary for a user to perform the processing for authenticating the mobile agent and the processing for allowing for accessing each time. Furthermore, the information suited to the user's taste may automatically be downloaded when the information processing terminal 3 is not in use, such as during e.g. the time of charging or standby time, even lacking the explicit and intentional retrieval operation of inputting the retrieval condition on the part of the user.

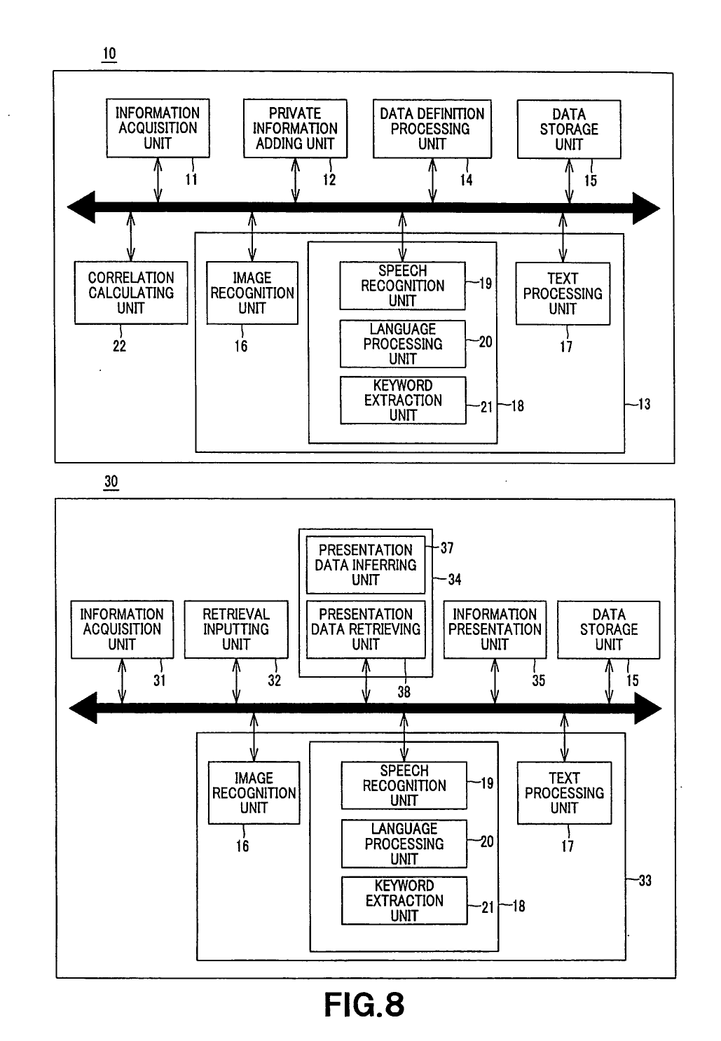

An example of the information processing terminal, capable of analyzing the user's taste as evaluation value, is now explained. An information terminal 3, applied to the concrete example of the present invention, is shown in FIG. 8. The information acquisition system 1 includes, as the information registration unit 10, an information acquisition unit 11 for acquiring the information pertinent to an experienced event, a private information adding unit 12 for adding the private information, a data recognition processing unit 13 for recognizing the acquired information, a data definition processing unit 14 for classifying the recognized data in accordance with the predetermined definition, and a data storage unit 15 for storage of the data classified according to the definition.

The information acquisition unit 11 is a means for acquiring the information around the user, and includes a means capable of acquiring the image information, speech information, position information and time/date, such as a camera, microphone or GPS. The data recognition processing unit 13 performs the processing of extracting the specified information from e.g. the image information, speech information, position information or time/date, as acquired by a camera, microphone or GPS. The data recognition processing unit 13 includes an image recognition unit 16, a text processing unit 17 and a speech processing unit 18. The image and the text of the image data acquired from the camera is subjected to image recognition processing and text recognition processing, by the image recognition unit 16 and the text processing unit 17, to extract specified image and text data. The speech data acquired from the microphone is processed by a speech recognition unit 19 to recognize the speech. The speech information is converted into text data by a language processing unit 20, and key data is extracted from the converted text data by a keyword extraction unit 21.

The data extracted by the data recognition processing unit 13 is classified in the data definition processing unit 14 in accordance with predetermined definitions. Examples of the definitions include an image of a person, the identification information pertinent to the image of the person, such as family, brothers/sisters, spouse, place of work, friends, age groups, place of residence or nationality, the degree of density as verified from image data (low or high), sort of the building, as verified from image data (sort of the service works, as may be surmised from placards), name of the buildings (letter/character strings), time/date, weather (fine, rainy or cloudy), atmospheric temperature (high or low), humidity (high or low), wind (strong or weak), position information (latitude, longitude or altitude), closest station, common name that may be understood only by the user, evaluation value and items of evaluation (conditions of site, evaluation of the salespeople, evaluation of goods, atmosphere of store, pricing, time of supplying cooking and other conditions). The acquired data are classified based on these definitions. The data storage unit 15 holds the data classified based on the above definitions.

The information registration unit 10 also includes a correlation calculating unit 22 for calculating correlation data between evaluation values for evaluation items given as the private information. These correlation data are stored in the data storage unit 15.

The case of exploiting the private information of the user, registered in the information registration unit 10, is hereinafter explained.

The information processing terminal 3 includes, as the information exploitation unit 30, an information acquisition unit 31, for acquiring the current state, a retrieval inputting unit 32, supplied with the retrieval conditions, a data recognition processing unit 33 for recognizing the acquired information, a retrieval unit 34 for extracting the information conforming to the retrieval conditions or the analogous information from the data storage unit 15, and an information presenting unit 35 for presenting the extracted information to the user.

The information acquisition unit 31 and the data recognition processing unit 33 acquire and recognize the position information of the current site, and the other information, by a method similar to that of the information registration phase. The retrieval inputting unit 32 is supplied with the retrieval conditions by the user. The inputting methods include the speech input, text input or the image input. In case the speech is input to the retrieval inputting unit 32, the data recognition processing unit 33 extracts the keyword pertinent to the time, site and the person from the text. In case the text data is input to the retrieval inputting unit 32, the data recognition processing unit 33 extracts the keyword from the text and, in case the image data is input to the retrieval inputting unit 32, the data recognition processing unit 33 extracts the keyword from the image. In the present concrete example, schedule management software may be used to extract a keyword from the schedule-registered information.

The retrieval unit 34 includes a presentation data inferring unit 27, for extracting the information, analogous to the retrieval conditions, from the data storage unit 15, and a presentation data retrieval unit 28, for extracting the information matched to the retrieval condition, from the data storage unit 15. In retrieving the information from the data storage unit 15, the database management system, used in the information registration unit 10, is used for retrieval. The information extracted by the retrieval unit is presented to the user by the information presenting unit 35 by the text data, audio guide, or the image display, taken alone or in combination.

With the present information processing terminal 3, an event experienced by a user may be stored along with the information reminiscent of the experience. The information obtained by retrieving the data storage unit 15 of the present device 1 is the information once experienced by the user, in contradistinction from the information obtained on keyword retrieval from the network, such as the Internet, thus allowing taking out the information of high utility and efficiency.

It is preferable that the information pertinent to the experienced event is automatically acquired by the camera, microphone or the GPS, as far as is possible, as in the example described above. The information processing terminal 3 according to the present invention is desirable under the circumstances that, in actuality, the user feels it difficult to leave a ‘memorandum’ consciously in connection with an event experienced by the user in person, and is liable to lose the chance of recording the crucial information, such that, if similar chance presents itself again, it is not possible to take advantage of the previous experience.

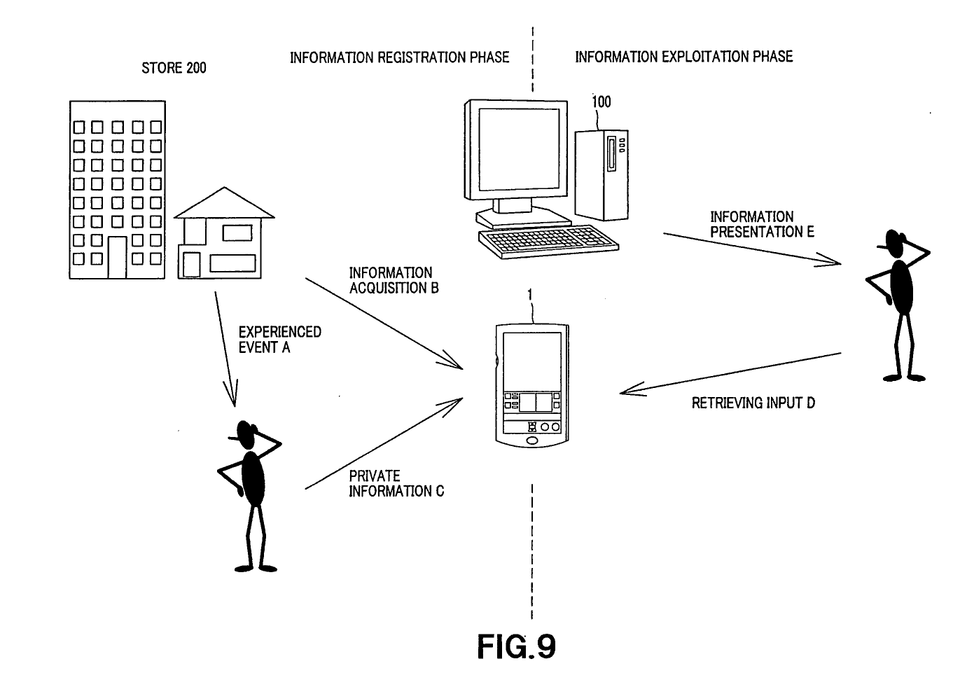

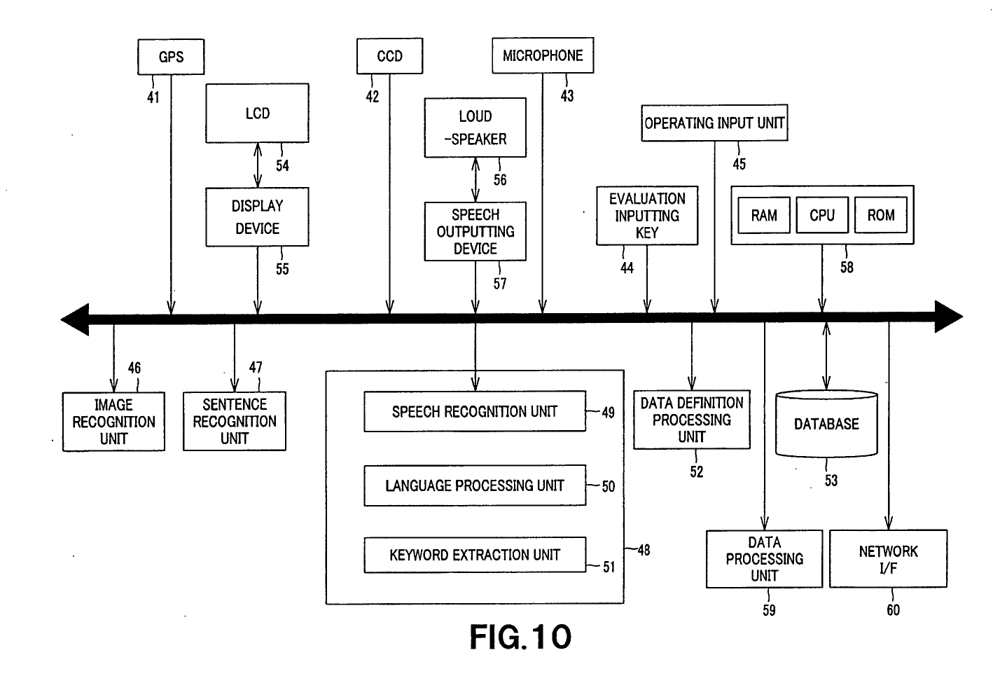

Referring to FIGS. 8 to 10, the information processing terminal 3, as a concrete example of the present invention, is explained in detail. FIG. 9 separately shows the information registration phase and the information exploitation phase, both of which are carried out using the information processing terminal 3. FIG. 9 shows the information registration phase and the information exploitation phase, which are shown separately and both of which are carried out using the information processing terminal 3. In FIG. 9, the information registration phase is a scene of registering the surrounding information and the private information when the user takes a meal in a restaurant, while the information exploitation phase is a scene where the past information pertinent to the restaurant is taken out on another opportunity. In the present concrete example, the correlation data are calculated in the information processing terminal 3 for the experience information and the private information obtained by the user taking a meal in the restaurants. FIG. 10 shows a concrete example of the information processing terminal 3.

Since it is crucial for a user experiencing an event to be carrying the information processing terminal 3, the information processing terminal 3 in the present concrete example is of the mobile type. Even though the private information management device is of the mobile type, it may be connectable to a device corresponding to e.g. a stationary PC 100 or a server device for household use so that the information acquired may be stored therein. In this case, it is sufficient that the data storage unit 15 of the information processing terminal 3 is provided independently on the side of the stationary PC 100 or of the server device so that the information will be transmitted/received wirelessly or over a wired communication interface between data storage unit and the main body unit of the information processing terminal 3.

Referring to FIG. 10, the information processing terminal 3 includes a GPS 41 for acquiring the position information, a CCD (charge coupled device) 42 for acquiring the information around the user, and a microphone 43. These components serve as the information acquisition unit 11 for the information registration phase and as the information acquisition unit 22 for the information exploitation phase, shown in FIG. 8. In this information processing terminal 3, image data and voice data are automatically acquired, without operations by the user. The CCD 42 and the microphone 43 transfer to a mode of generating and storing storage form data, based on a data model, at a preset time interval, or with changes in the environment around the user, for storing the data. For example, detection of a large sudden sound, or detection of a keyword specified by a keyword extraction unit 51, is used as a trigger for information acquisition. In the explanation of the present concrete example, the information around the user, acquired by the information acquisition unit 11, is termed the experience information, as necessary.

The information processing terminal 3 also includes an evaluation inputting key 44, as a private information addition unit 12 for the user to add the private information, and an operating input unit 45 for a retrieval input in the information exploitation phase or for an operating input for this device. The evaluation inputting key 44 may be a simple pushbutton for inputting points corresponding to the number of times of pressing operations, or an operating input key, such as a ten-key, capable of directly inputting the evaluation values. In the present concrete example, the evaluation of ‘best’, ‘acceptable’, ‘good’, ‘bad’ and ‘worst’ is given, depending on the number of times of the pressing operations. The evaluation input from the evaluation inputting key 44 does not necessarily have to be entered simultaneously with the experience of the user. That is, the evaluation input may be made, in connection with the experienced event, at a time later than the time of the information acquisition.

The information processing terminal 3 may be provided with a structure for acquiring the weather information, such as atmospheric temperature, humidity or weather, as a structure corresponding to the information acquisition unit 11, in addition to the above-described structure. The technique for acquiring the position information or the weather information may be exemplified by having the position information or the weather information periodically distributed in addition to receiving the base station information periodically transmitted from the base station, as is already realized in the field of a mobile phone. The information processing terminal 3 may also be provided with a simple temperature or humidity sensor.

The information processing terminal 3 includes an image recognition unit 46, a sentence recognition unit 47 and a speech recognition unit 48 for recognizing the image data, sentence data and speech data acquired, respectively. The image recognition unit 46 executes image recognition processing on the image data acquired from the CCD 42. For example, it executes the processing of recognizing and extracting a face portion of a person. The sentence recognition unit 47 executes text recognition processing on image data acquired from the CCD 42. For example, it executes the processing of recognizing letter/character strings or symbols in the image, such as letters/characters in a placard, to extract the name of the building or the sign as text data. The speech recognition unit 48 includes a speech recognition processing unit 49, a language processing unit 50, and a keyword extraction unit 51. The speech recognition processing unit 49 recognizes and processes speech data acquired from the microphone 43 as speech. The language processing unit 50 converts the speech data into text data, and the keyword extraction unit 51 extracts the key word from the as converted text data.

The information processing terminal 3 also includes a data definition processing unit 52 for giving definitions to the data extracted by the image recognition unit 46, sentence recognition uni 47 and the speech recognition unit 48. The data definition processing unit 52 is equivalent to the data definition processing unit 14 for the information registration phase and to the retrieval unit 25 for the information exploitation phase, and classifies the extracted data in accordance with the pre-determined definitions or retrieves the information from a database 53 in accordance with the retrieval conditions.

In the database 53 of the information processing terminal 3, there are registered, for example, image data and text data stating the information pertinent to the image data. For example, for image data of a face of a person, there are stored names, addresses, sites of contact or ages of friends in associated manner. There is also stored the information of families, brothers/sisters, spouse, people in the place of work, friends, and so forth, if any, that are pertinent to this person. The persons, sorts or names of the buildings (letter/character strings), as determined from image data, text data and speech data, extracted by the image recognition unit 46, sentence recognition unit 47 and the speech recognition unit 48, are compared to data stored in the database 53, so as to be classified and stored as new data. Among the definitions, there are, for example, the position information (latitude, longitude or altitude), time/date data, weather information (fine, rainy or cloudy), atmospheric temperature (high or low), humidity (high or low), wind (strong or weak), closest station, common names that may be understood only by the user, evaluation values and items of evaluation (conditions of site, evaluation of the salespeople, evaluation of goods, atmosphere of store, pricing, time of supplying cooking and other conditions). The acquired data are classified based on these definitions.

The data acquired and defined are model-converted, in accordance with a data model, and stored in the database 53, using a database management system (DBMS). Examples of the techniques for model conversion include the technique consisting in defining the data in a tabulated form and managing the tabulated data in accordance with the DBMS with use of a relational database (RDB), and a technique of classifying the data using the RDFs (Resource Description Framework Schema)-OWL (Web Ontology Language) and managing the so classified data in accordance with the DBMS with use of RDFDB (RDF database) or XMLDB (XML database). The information pertinent to the event experienced by the user, or the private information, stored in the database 53, may be edited later, if so desired by the user.

The information processing terminal 3 includes a data processor 59 equivalent to the correlation calculating unit 22 in FIG. 8. The data processor 59 calculates, as the evaluation values, the evaluation values for each item entered by the user, and the correlation thereof, for items entered by the user. The method for calculating the correlation will be explained subsequently. The correlation data of the private information, thus calculated, are recorded in the database 53.

The information processing terminal 3 also includes, as a structure for presenting the information to the user, a liquid crystal display (LCD) 54, as display, a display device 55, a loudspeaker 56 and a speech outputting device 57. The information processing terminal 3 also includes a network interface (network I/F) 60 for transmitting the correlation data, experience data and the private information to external equipment, such as management server 4.

The above-described structures are comprehensively controlled by a CPU, a ROM having stored therein e.g. processing programs, and a controller 58, provided with a RAM, as a work area for the CPU.

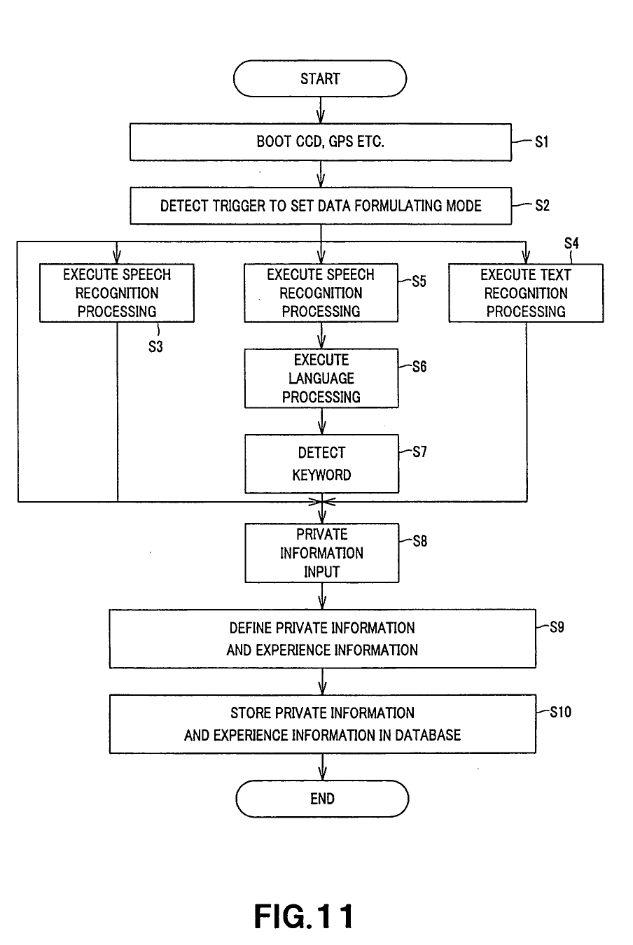

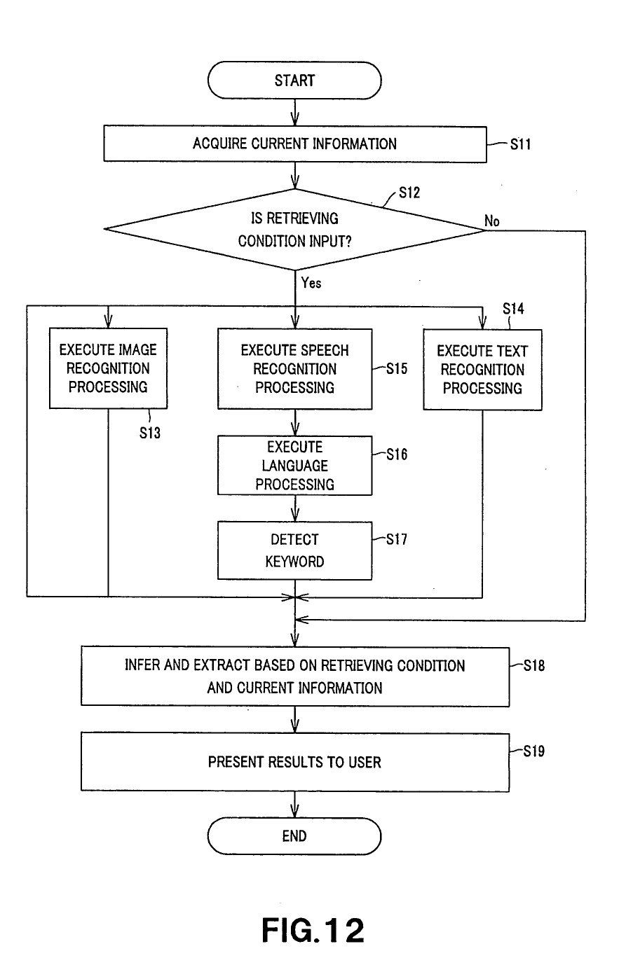

Referring to FIGS. 9, 11 and 12, the case of registering the information pertinent to the experienced event (experience information) and the private information, by a user, with the aid of the aforementioned information processing terminal 3, is hereinafter explained. FIGS. 11 and 12 illustrate the information registration processing for a case where a user takes a meal in a restaurant (store) and the information exploitation processing of subsequent exploitation of the registered information, respectively.

First, the case where the user acquires the experience information in a restaurant 200 and the private information, is explained. When the user, carrying the aforementioned information processing terminal 3, takes a meal in the restaurant 200 (arrow A in FIG. 9), the information pertinent to the experienced event is acquired by the information processing terminal 3 (arrow B in FIG. 9). The information acquired here is classified into the experience information and the private information. The experience information is mainly acquired automatically by the information processing terminal 3. The private information is entered by the user (arrow C in FIG. 9). It is noted that the private information may or may not be entered simultaneously with the acquisition of the information pertinent to the experienced event.

As for the timing of the acquisition of the experience information, it is sufficient if the user sets the mode of automatically acquiring the information at a preset interval before walking into the restaurant 200. However, in a usual case, the user cannot consciously execute this mode setting operation. According to the present invention, the information pertinent to the experienced event is desirably acquired without the user becoming conscious about it, and hence the experience information is to be acquired automatically, with changes in the surrounding states as a trigger, as far as is possible. For example, if a sentence “May I help you?” is defined at the outset, as a keyword for trigger, the data formulating mode is entered when the user steps into the restaurant 200 and the information processing terminal 3 has detected the sentence “May I help you?” operating as a trigger (steps S1 and S2 of FIG. 11).

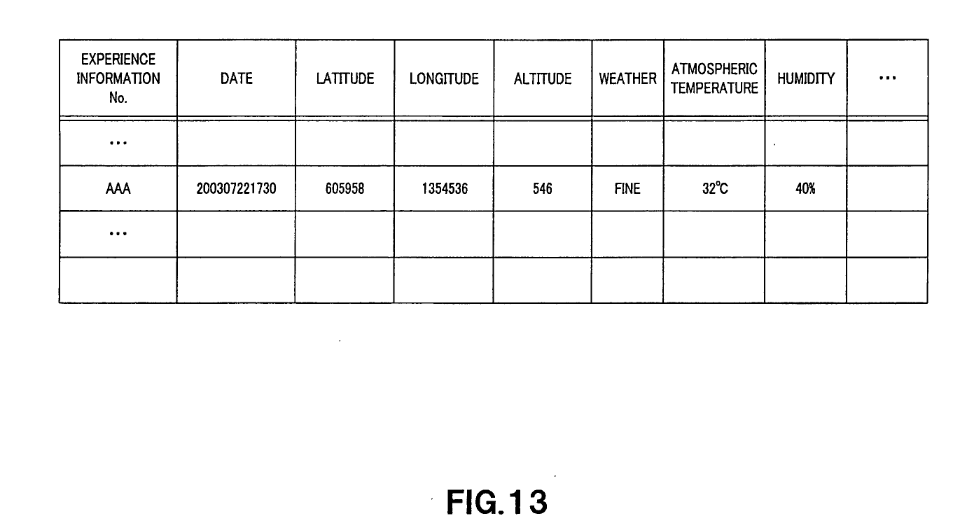

FIG. 13 shows an example of the experience information acquired at this time. It is assumed that, although data is entered only insofar as it is necessary for explanation, for convenience, data are also entered in the void cells. If the time information acquired is 2003, Jul. 22, 17:30, it is registered as “20030722173”, while the position information is expressed as “605958, 1354536, 546) (60°59′58″ latitude, 135°45′36″ longitude and 546 m altitude). Additionally, the information on attendant states, such as the weather information, transmitted from the base station, is annexed. Moreover, if there is any fact that has become apparent from the information acquired before acquisition of the experience information, such information is also annexed. In the present concrete example, this information is that pertinent to the accompanying person(s). The time information, acquired here, may be the correct time information, contained in the GPS data, or may e.g. be “2003/07/22 night” or may be an abstract expression, such as “daytime”, “night”, “holiday” or “workday”. The position information may be a station name, a building name, a name of establishment or a common name accustomed to the user, because these names may be taken out as more intelligible and user friendly information when the user performs retrieval in the information exploitation phase.

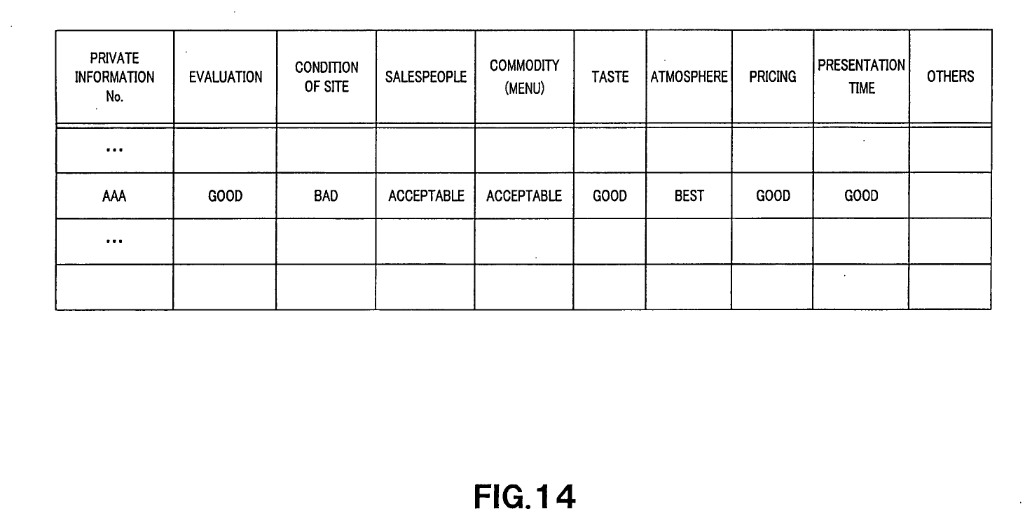

FIG. 14 shows an example of the private information as entered by the user. The private information is the overall evaluation, conditions of site, evaluation of the salespeople, evaluation of goods, atmosphere of store, pricing, time of supplying cooking and the more detailed evaluation on other conditions. Each evaluation may be recorded by the number of points actually entered by the aforementioned pushbutton type input keys.

The timing for the user to enter the private information (arrow C in FIG. 9) may be arbitrary, as described above. The private information may be added later to the acquired information. In the present concrete example, the user may be prompted to input the private information by generating the sound or by vibrations when the user has finished the experience in the restaurant 200, that is, when the user has moved from this restaurant to another place. There may, of course, be provided a mode which allows for acquisition of the experience information or for the inputting of the private information on the part of the user.

If, when the information processing terminal 3 has booted the CCD or the GPS in a step S1, and is in a standby state, a trigger is detected, the information processing terminal 3 in a step S2 moves to a data formulating mode, and acquires the experience information. The experience information, acquired in a step S2, is recognized and processed as from a step S3. If the experience information acquired is image data, the image recognition processing is carried out on image data acquired from the CCD 42 in a step S3. If the experience information acquired is the image data, and the letter/character information is contained in the image, the sentence recognition unit 47 in a step S4 executes text recognition processing on image data acquired from the CCD 42, and recognizes the letter/character string, in the image, such as the letters/characters of e.g. a placard, and extracts the name of the building or the sign as text data. If the experience information acquired is the speech data, the speech recognition processing unit 49 in a step S5 performs speech recognition processing on the acquired speech data. Then, in a step S6, the language processing unit 50 converts the speech information into text data and, in a step S7, the keyword extraction unit 51 extracts the keyword from the text data. The GPS data, acquired by the GPS 41, such as the position data or the date/time data, and the text data, entered by the information presenting unit 35, may directly be used, and hence the information processing terminal 3 proceeds to the next step.

In a step S8, the information processing terminal 3 accepts the inputting of the private information from the user. At this time, the information that could not be acquired as the experience information, such as the store name C store site, is entered simultaneously by the user. However, the private information does not have to be entered at this stage. The mode for the user to input only the private information is also provided. The data obtained from the acquired information ae classified in a step S9, based on the definition, and are stored in the database 53 in a step S10.

By the above processing, the experience information and the private information of the user are put into order and stored in the database 53 in such a manner as to permit facilitated retrieval.

The case of exploiting the user's private information, registered in the information registration unit 10, is now explained with reference to FIGS. 9 and 12. Here, the case of the user retrieving the information pertinent to restaurants is explained.

The information processing terminal 3 is supplied with information retrieval conditions (arrow D in FIG. 9). The retrieval conditions supplied may be automatically selected, with the keyword, contained in the information derived from the user's current state, as acquired by the private information management device per se, as a retrieval key. In addition, the conditions directly entered by the user may be used. Among the techniques for a user to input the retrieval conditions, there are such techniques by manual inputting, from item to item, based on the GUI for inputting the retrieval conditions, by speech input in keeping with the guidance, and by simple utterance of the keyword. In the following, the case in which the retrieval condition is input from the user by speech is explained.

In a step S11, the information processing terminal 3 acquires the position information of the current site, and the other information, by a method similar to that for the information registration phase. In the next step S12, it is verified whether or not the retrieval condition has been entered. If the retrieval condition has been entered by the user, the keyword is extracted, depending on the inputting method. In case the user has entered the retrieval condition by speech, for example, in case the user has uttered “restaurant with amicable atmosphere” to the information processing terminal 3, the speech recognition unit 38 executes the speech recognition processing, and extracts the keyword “atmosphere”, “amicable” and “restaurant”.

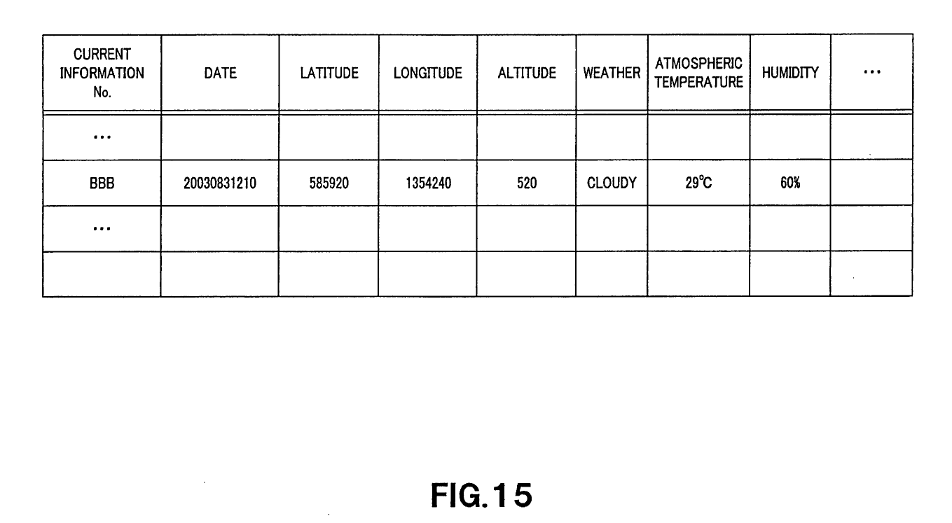

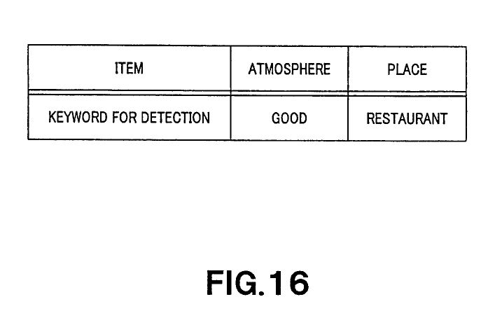

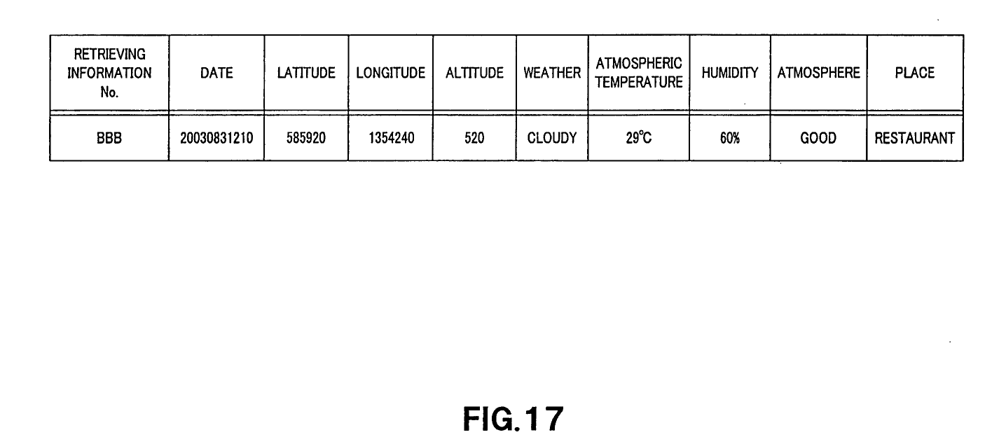

The position information of the current site, acquired at this time, and the other information, are referred to below as the current information. FIGS. 15 and 16 show the current information acquired in the step S11 and the retrieval condition acquired in the step S12, respectively. In association with the numbers of the acquired information, the time information for Aug. 31, 2003, 12:10 is represented as “200308311210”, while the position information 58°59′20″ latitude, 135°42′40″ longitude and 520 m altitude is represented as “585920, 1354240, 520”. In addition, the information pertinent to the attendant circumstances, such as the weather information, transmitted from the base station, for example, is acquired. The retrieval conditions, acquired by the information processing terminal 3, are “good” atmosphere and name of the place being the “restaurant”, as shown in FIG. 16. Thus, these data are added to data used as the retrieval condition, such that the set of data shown in FIG. 17, including these data, becomes a keyword for the retrieval conditions.

The experience information, acquired in the step S12, is recognized and processed in the processing of a step S13 and in the following steps. If the information is the experience data, the image recognition processing is carried out on image data acquired from the CCD 42 in the step S13. If the information is the image data and the letter/character information is contained in the image, the sentence recognition unit 37 in a step S14 executes the text recognition processing on the image data acquired from the CCD 42. For example, the sentence recognition unit 47 executes the text recognition processing on image data acquired from the CCD 42, and recognizes the letter/character string or the symbol in the image, such as letters/characters in a placard, to extract the name of the building or the sign as text data. If the information is speech data, the speech recognition processing unit 39 in a step S15 performs speech recognition processing on the acquired speech data. In the next step S16, the language processing unit 50 converts the speech information into text data and, in the next step S17, the keyword extraction unit 51 extracts the keyword from the text data. If the information is text data or GPS data, processing transfers directly to the next step 18. If no retrieval condition has been entered in the step S12 from the user, processing similarly transfers directly to the next step S18.

In the step S18, the information including the retrieval conditions and the information analogous with the retrieval conditions are extracted from the database 53, based on the current information extracted in the steps S12 to S17 and the retrieval condition entered by the user. For extracting the information retrieved from the database by the user, the database management system used in the information registration unit 10 is used. For example, memory based reasoning (MBR) and the distance between two points (Euclid distance) is used. As for the retrieval method, if such a case is found in which all items of the information stored in the database are available, the evaluation values for the experience entered by the user are prioritized, whereas, if the totality of the items are not available, priority is placed on the items with a higher degree of matching. The information of other experiences, having evaluation values as specified by the retrieval conditions input by the user, may also be retrieved.

The information extracted by the data definition processing unit 52 as the retrieval unit is presented in a step S19 to the user by text data, voice guide, image display, or combination thereof (arrow E in FIG. 9).

If the retrieval condition has been input by the user in the step S11, retrieval is carried out based on the keyword of the retrieval condition. If the retrieval condition has not been input, retrieval is carried out under a condition analogous to the current information. For example, if the current place is the restaurant, and the user visited this restaurant in the past, the result of evaluation at such past time is presented. If the user did not visit this restaurant in the past, the information on a near-by restaurant the user visited in the past is presented. If in retrieval condition has been entered, but the current time is the meal time, the information on the restaurant near the user's current site is presented.

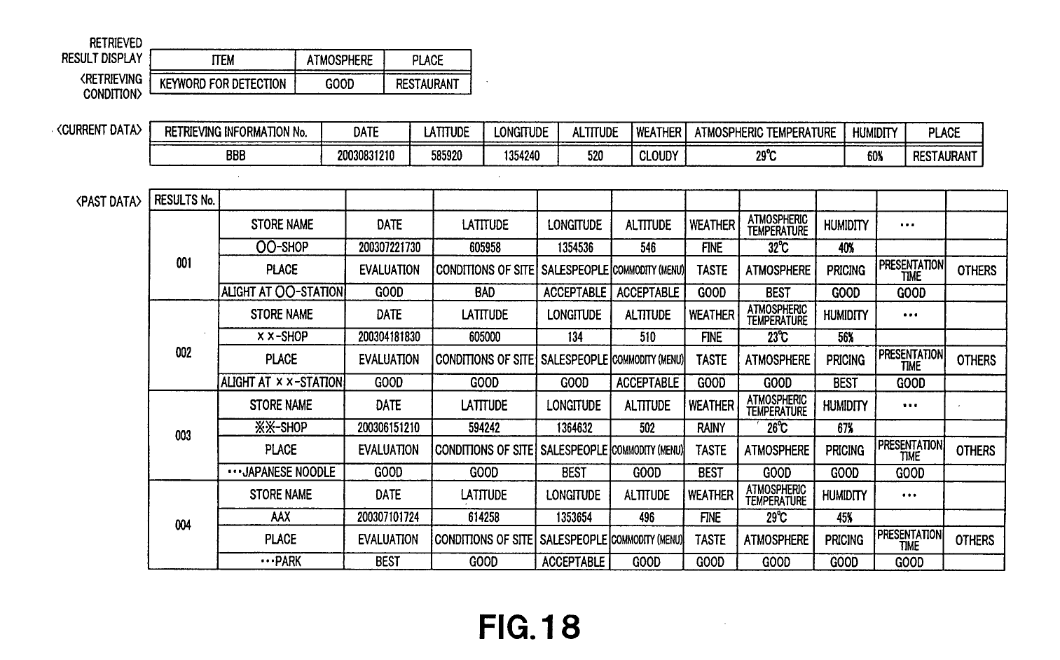

A data example, displayed as being the result of retrieval, is shown in FIG. 18. Retrieved results 001, 002, 003 and 004 are displayed against the input current information and retrieval conditions. These past data are the information experienced by the user. As for the display order, the contents of the retrieval conditions by the user are given the priority. For example, if the user has entered “near”, display is by placing priority on being “near” to the current site, rather than on the high information evaluation.

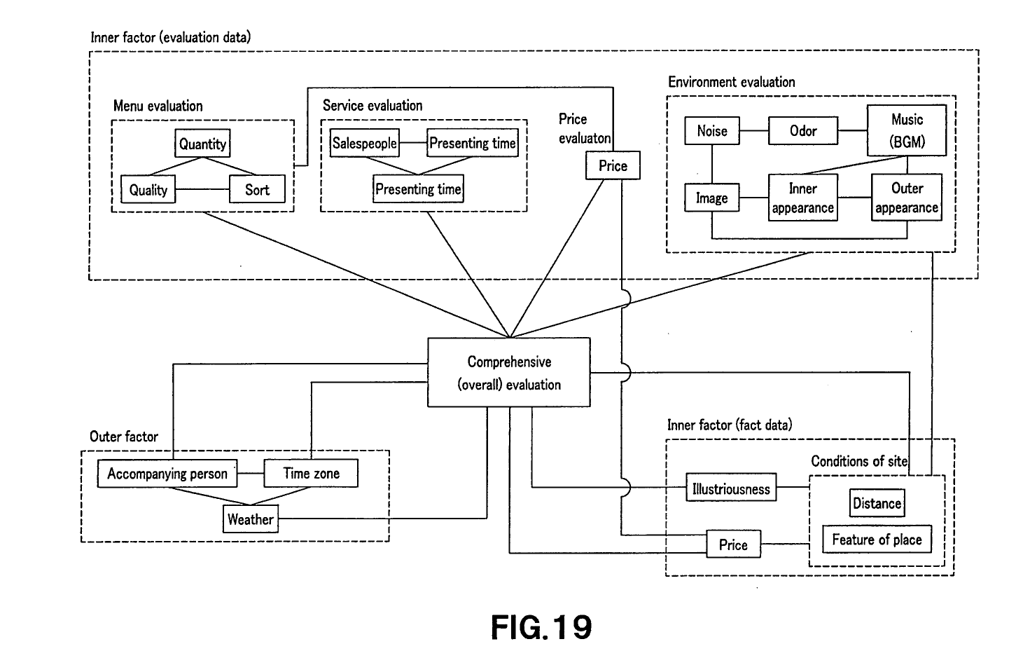

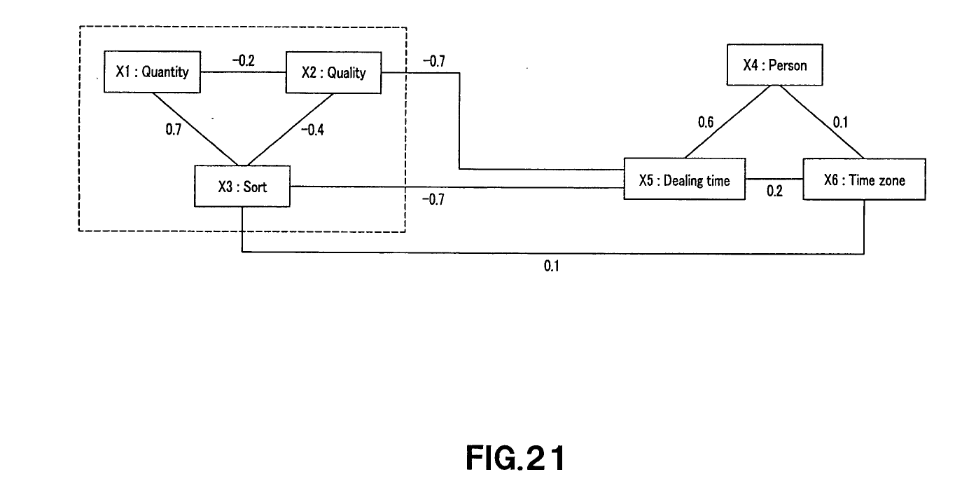

The processing of the data processor 59 finding the correlation data against five stages of the evaluation, entered by a user, is now explained with reference to FIGS. 19 to 22. FIG. 19 schematically shows correlation data between the private information and the experience information as calculated by the information processing terminal 3. Referring to FIG. 14, the private information input is classed into categories such as “menu”, “salespeople”, “price” or “atmosphere”. The private information, shown in FIG. 14, is given only by way of illustration, such that any items that may be evaluated may be added as necessary by a user.

The data processor 59 calculates the correlation between items within each category and ultimately finds the correlation between these categories and the comprehensive evaluation (overall evaluation). These items may be classed into evaluation data, evaluated by the user, fact data based on facts, inner factors directly related to the contents of the event experienced by the user, and outer factors indirectly acting on the event. The fact data is the information concerning the illustriousness (brand-related evaluation) such as the information: ‘a hotel ∘∘ is a first-class hotel (or it is so rumored); hence the fee must be high” and the information concerning e.g. the service fee surmised from the illustriousness. The “conditions of site” or place characteristics are also comprised in these fact data. The outer factors may also include parameters indirectly acting on the “experience”, such as weather at the time of the experience, time zones or the accompanying person.

Since the fact data differ from evaluation data, variable under the operating conditions, a constant value, independent from the evaluated values by the user, is provided at the outset, and is used in finding the correlation data. A preset value is also given the parameter that may not be evaluated objectively, such as “accompanying person”.

Of the blocks interconnected by solid lines in FIG. 19, the correlation may be found. The blocks indicated by broken line are in the same categories.

In the present concrete example, partial correlation coefficients are used as an example of the correlation data calculated in the data processor 59. For the private information, entered by the user, as shown in FIG. 14, and for correlation coefficients x₁, x₂, . . . , xₙ, as the values for evaluation, the correlation coefficients therebetween are found by the following equation (1):

$${γ}_{ij \cdot k} = \frac{{γ}_{ij} - {γ}_{ik} {γ}_{jk}}{\sqrt{( 1 - {γ}_{ik}^{2} ) ( 1 - {γ}_{jk}^{2} )}} \qquad ( 1 )$$

For example, if “menu evaluation”, “service evaluation” and “overall evaluation” are considered, p(x_{ia, x}ⱼ) i=1 to 7, j=1 to 7 are found for a “quantity” x₁, the “quality” x₂, “sort (of menu)” x₃, “demeanor of persons (salespeople) x₄, “dealing time” x₅ and “providing time” x₆ and “overall evaluation” x₇.

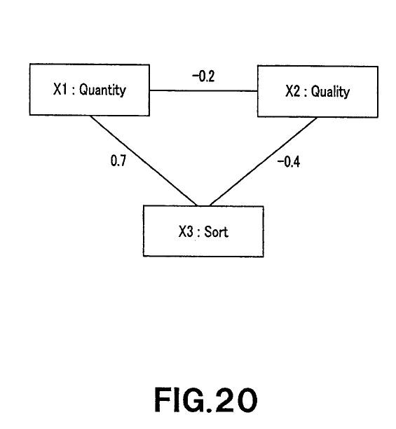

For example, for the respective elements of each item of a given category (menu), the partial correlation coefficients γᵢ, γⱼ between the variables, such as x₁-x₂, x₁-x₃ and so forth, are calculated. The value of the partial correlation coefficient, among the partial correlation coefficients, thus calculated, which has the smallest absolute value, is set to 0, and the values of the other partial correlation coefficients are estimated. From this, directionless independent graph, representing the correlation among x₁ (quantity), x₂ (quality) and x₃ (sort), shown for example in FIG. 20, may be formed.

The partial correlation coefficients among x₁ to x₆ are calculated in similar manner. The value of the partial correlation coefficient, among the partial correlation coefficients, thus calculated, which has the smallest absolute value, is set to 0, and the values of the other partial correlation coefficients are estimated. From this, a chain independent graph among x₁ (quantity), x₂ (quality), x₃ (sort), x₄ (person), x₅ (dealing time) and x₆ (time zone), is formed. In this graph, x₄ (person), x₅ (dealing time) and x₆ (time zone) are elements of the category “service evaluation”.

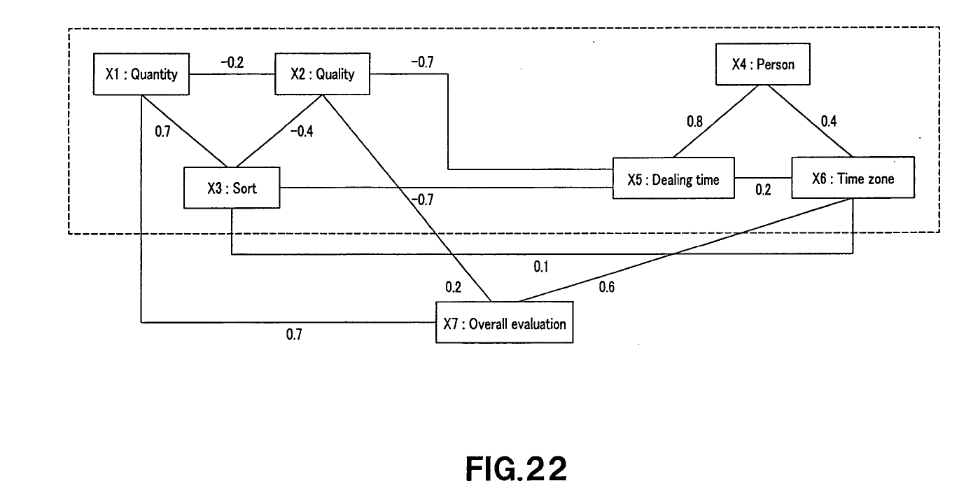

A chain independent graph among x₁ to x₇, shown in FIG. 22, is ultimately formed, by calculating the partial correlation coefficients between the respective elements and the “overall evaluation”. If the number of variables is increased, correlation with the newly added variables presents itself in the partial correlation coefficients, and hence the values different from the previous correlation values are calculated. Hence, in the present concrete example, the ultimately obtained partial correlation coefficients are replaced by the correlation calculated from one element in the category to another, in order that the correlation among the respective elements making up the category will be maintained in each category in the ultimate results.

In this manner, correlation data may systematically be calculated of the experience information acquired for an event experienced by the user, and the private information, as shown in FIG. 19. More detailed information may also be obtained by calculating the partial correlation coefficients of the respective elements of the so input private information. For example, even if plural users give the overall evaluation “best (5)” for the restaurant A, the rich menu (menu evaluation may contribute to the overall high evaluation for the user a and the good service (service evaluation) may contribute to the overall high evaluation for the user b, in which case the evaluation differs in this point between the two users. It is moreover possible to know the information as to what is the factor that has led to the outstanding evaluation, more specifically, under what situation a given user gives a judgment ‘good’ and a judgment ‘bad’, simply based on the evaluation value entered by the user. From the correlation data, it is similarly possible to obtain the information representing the condition under which the user gives a judgment “good” or a judgment “bad” or the information representing the overall taste for an event.

The information acquisition system 1 executes automatic retrieval processing, using a keyword, such as a category, featured by the so calculated correlation data, as a retrieval keyword.

In the information acquisition system of the present invention, the cipher key data KEK, issued in the management server as the authentication information, which renders browsable the information provided by the storage server, does not necessarily be in the form of data. For example, the authentication information, issued by the management server, may also be sold as system use rights in the form of a commodity, such as a pre-paid card. In this case, authentication of the user in person is not necessary in the sale server. From the user terminal, encrypted cipher key for encryption EN (DEK) may be decoded if there is the information equivalent to the cipher key data KEK contained in the information sold as use rights, and the encrypted data EN (DATA), publicized in the storage server, may be decoded with the decoded cipher key DEK. The result is a system of high secrecy by a highly simplified scheme.

1. An information acquisition system comprising:
an information providing device, including data storage means, having data stored therein, and data transmitting means for transmitting data specified from said stored data to outside;
an information processing terminal, including taste information acquisition means for acquiring taste information representing a taste of a user, retrieval information generating means for generating retrieval information based on the taste information, information retrieving means for retrieving information matched to the retrieval information from said information providing device, and information presenting means for presenting a retrieved result to said user; and
a management device for supervising a connection of said information processing terminal to said information providing device; and wherein
said information providing device, said information processing terminal and said management device are interconnected over a network.

2. The information acquisition system according to claim 1 wherein said information processing terminal includes, as said taste information acquisition means, information acquisition means for acquiring experience information pertinent to an event experienced by the user; and wherein the information acquisition system further comprises:
private information adding means for adding private information, privately needed by the user, as an evaluation value, to the experience information;
storage means for storing said experience information and the private information;
data storage controlling means for classifying the experience information, added by said based on attributes, and for storing classified experience information in said storage means; and
correlation calculating means for calculating a correlation value among evaluated values; wherein
said information retrieving means retrieves information matched to information featured by said correlation value, as the retrieval information, from said information providing device; and wherein said information presenting means presents a retrieved result for said user.

3. The information acquisition system according to claim 1 wherein:
said management device includes cipher key generating means for generating a first cipher key for supervising a connection of said information processing terminal to said information providing device;
said information providing device includes:
cipher key generating means for generating a second cipher key for data encryption, used for encrypting data stored in said data storage means, with the first cipher key having been received over said network from said management device, and
key encrypting means for encrypting the second cipher key for data encryption, with encrypted data and encrypted cipher key being stored in said data storage means; and said information processing terminal includes:
retrieval information encrypting means for encrypting said retrieval information using the first cipher key received over said network from said management device,
cipher key decoding means for decoding the encrypted cipher key using the first cipher key
data decoding means for decoding the encrypted data using the second cipher key and
comparing means for comparing the encrypted retrieval information to the encrypted data.

4. An information acquisition method for acquiring information stored in an information providing device including data storage means, by use of an information processing terminal of a user, said information providing device and the information processing terminal being interconnected over a network, with a management device, said method comprising:
a taste information acquisition step of acquiring taste information representing a taste of the user;
a retrieval information generating step for generating retrieval information based on the taste information;
an information retrieving step of retrieving information, matched to the retrieval information, from said information providing device; and
an information presenting step of presenting retrieved results to said user.

5. The information acquisition method according to claim 4 wherein said taste information acquisition step includes an information acquisition step of acquiring experience information pertinent to an event experienced by the user; and wherein the information acquisition method further comprises:
a private information adding step of adding private information, as needed privately by the user, to the experience information, as an evaluation value;
a storage step of storing said experience information and the private information in a storage means;
a data storage controlling step of classifying the experience information, according to attributes, for storage in said storage means; and
a correlation calculating step of calculating a correlation value among evaluation values; wherein
by use of information featured by said correlation value, as the retrieval information, information matched to said retrieval information is retrieved in said information retrieving step, and wherein
the retrieved result is presented to said user in said information presenting step.

6. The information acquisition method according to claim 4 further comprising:
in said management device:
an encryption key generating step of generating a first cipher key for supervising a connection of said information processing terminal to said information providing device;
in an information presenting terminal:
a cipher key generating step of generating a second cipher key for data encryption for encrypting data stored in said data storage means, and
a key encrypting step of encrypting the second cipher key by use of the first cipher key received over said network from said management device; and
in said information processing terminal:
a retrieval information encrypting step of encrypting said retrieval information by the first cipher key,
a cipher key decoding step of decoding the second cipher key using the first cipher key,
a data decoding step of decoding encrypted data using the second cipher key, and
a comparing step of comparing said encrypted retrieval information to said encrypted data.

7. An information program for an information processing terminal, the program comprising computer executable instructions for executing:
an information acquisition step of acquiring experience information pertinent to an event experienced by a user;
a private information adding step of adding private information, as needed privately by the user, to the experience information, as an evaluation value;
a storage step of storing the experience information and the private information in a storage means;
a data storage controlling step of classifying the experience information, according to attributes, for storage in said storage means;
a correlation calculating step of calculating a correlation value among evaluation values;
a taste information acquisition step of acquiring taste information representing the taste of the user;
a retrieval information generating step of generating retrieval information based on the taste information;
an information retrieving step of retrieving information matched to the retrieval information, from another information processing apparatus connected to a network; and
an information presenting step of presenting a retrieved result to said user, wherein information featured by said correlation value is used as the retrieval information to retrieve information matched to said retrieval information, and the retrieved result is presented to the user.
